(19) United States
(12) Patent Application Publication
(10) Pub. No.: US 2024/0354685 A1
(43) Pub. Date: Oct. 24, 2024

(54) SYSTEM FOR DISPLAYING AND METHOD FOR CALCULATING MONITORING-POINT STATE

(71) Applicant: ZHEJIANG DEKAN ENVIRONMENTAL TECHNOLOGY CO., LTD., Tongxiang City Jiaxing (CN)

(72) Inventors: Junfeng SHEN, Tongxiang City Jiaxing (CN); Junling SHEN, Tongxiang City Jiaxing (CN); Mengting CAO, Tongxiang City Jiaxing (CN); Yinglei HAN, Tongxiang City Jiaxing (CN); Chenhui PAN, Tongxiang City Jiaxing (CN)

(73) Assignee: ZHEJIANG DEKAN ENVIRONMENTAL TECHNOLOGY CO., LTD., Tongxiang City Jiaxing (CN)

(21) Appl. No.: 18/762,411

(22) Filed: Jul. 2, 2024

Related U.S. Application Data
(63) Continuation of application No. PCT/CN2023/100658, filed on Jun. 16, 2023.

(30) Foreign Application Priority Data
Jul. 18, 2022 (CN) 202210842085.2

(51) Int. Cl. G06Q 10/0639; G06Q 50/10

(52) U.S. Cl. CPC G06Q 10/06393; G06Q 50/10

(57) ABSTRACT

A system for displaying a monitoring-point state on software and a method for calculating the monitoring-point state, based on determination by on an Internet of Things sensor on whether termites exist or not are provided in the disclosure. The system includes an initial state block, a termite-existing state block, an in-killing state block, a killing-complete state block, an off-line state block, a lost state block and a shifting state block. The method includes determining whether termite exists according to a signal sent by a monitoring point so as to calculate a number of monitoring points in a termite-existing state or an initial state, and determining whether proper handling is performed according to received handling information to calculate a number of monitoring points in an in-killing state. The disclosure uses the Internet of Things sensor and information technology to accurately and completely display the different states of respective monitoring points.

### CROSS REFERENCE TO THE RELATED APPLICATIONS

This application is a continuation of International Application No. PCT/CN2023/100658 filed 16 Jun. 2023, which claims the benefit of priority to Chinese Application No. 202210842085.2, filed 18 Jul. 2022, the benefit of priority of each of which is claimed herein and which applications are hereby incorporated by reference herein in their entirety.

### TECHNICAL FIELD

The disclosure relates to the technical field of pest prevention and control, in particular to a system for displaying a monitoring-point state on software and a method for calculating the monitoring-point state, based on determination by on an Internet of Things sensor on whether termites exist or not.

### BACKGROUND ART

It is estimated that global direct economic loss caused by termite harm is as high as tens of billions of dollars every year. China is one of the countries seriously harmed by termites. Termite harm emerges in a wide range of areas, house construction, water conservancy and hydropower establishment, cultural relics and ancient architectures, landscape architecture, or agriculture, forestry, and fruit trees are all targeted by termite harm. Economic losses caused by termite harm to house construction amount to billions of yuan every year, and economic losses caused by destruction of cultural relics and ancient architectures, reservoir dams, power cables, books, files, papers and clothes are even more immeasurable. In addition, termites do great harm to crops such as rice, wheat, corn, peanuts, tea and mulberry, and trees such as cedar, eucalyptus, poplar, hickory and bayberry.

At present, most of termite prevention and control systems on the market are traditional chemical barrier strips and manual inspections. It is easy for the chemical barrier strips to cause environmental pollution, with low efficiency, high cost and poor effect, and there is little chance to have an automatic monitoring function; even if there is an automatic monitoring function, a full-coverage monitoring network based on Internet of Things technology cannot be formed, and monitoring of termite activities and pest prevention and control are not accurate and efficient enough, which is unsatisfactory.

In traditional termite monitoring technology, only pests at a certain place can be reported immediately, but occurrence and development of pests in various regions cannot be recorded and displayed, nor history of pest occurrence cannot be recorded and traced. There is no monitoring state that changes according to actual situations, and thus users can only know a current situation, and it is unknown even when devices fail or is lost, which still needs on-site inspections so as to be confirmed, with inaccurate and lagging information, which is not conducive to effective development of pest prevention and control operations.

### SUMMARY

In view of technical problems that for the traditional termite monitoring technology, states and change in state of respective monitoring points cannot be fully known, termite handling can't be traced and known, or abnormal device operations can't be found in time, a system for displaying a monitoring-point state on software and a method for calculating the monitoring-point state, based on determination by on an Internet of Things sensor on whether termites exist or not are provided in this disclosure, which can accurately and completely display different states of respective monitoring points by using the Internet of Things sensor and information technology.

In order to solve above problems, a system for displaying a monitoring-point state is provided in the present disclosure, which includes an initial state block configured for displaying a number of monitoring points in an initial state; an termite-existing state block configured for displaying a number of monitoring points in an termite-existing state; an in-killing state block configured for displaying a number of monitoring points in an in-killing state; a killing-complete state block configured for displaying a number of monitoring points in a killing-complete state; an off-line state block configured for displaying a number of monitoring points in an off-line state; and a lost state block configured for displaying a number of monitoring points in a lost state.

Optionally, the initial state block is further configured for calculating and recording the number of monitoring points in the initial state, the termite-existing state block is further configured for calculating and recording the number of monitoring points in the termite-existing state, and the in-killing state block is further configured for calculating and recording the number of monitoring points in the in-killing state; the killed state block is further configured for calculating and recording the number of monitoring points in the killing-complete state; the off-line state block further configured for calculating and recording the number of monitoring points in the off-line state; and the lost state block is further configured for calculating and recording the number of monitoring points in the lost state.

Optionally, the system further includes a displaced state block for displaying a number of monitoring points in a displaced state.

Optionally, the system further includes a monitoring point distribution profile block for displaying distribution positions of monitoring points on the map. The monitoring point distribution profile block is associated with the initial state block, the termite-existing state block, the in-killing state block, the killing-complete state block, the off-line state block, the lost state block and the displaced state block.

Optionally, the system further includes a login permission configuration block connected with the initial state block, the termite-existing state block, the in-killing state block, the killing-complete state block, the off-line state block, the lost state block and the displaced state block.

In order to achieve objects of the disclosure, a method for calculating a monitoring-point state is further provided in the disclosure, which includes: determining whether termite exists according to a signal sent by a monitoring point so as to calculate a number of monitoring points in a termite-existing state or an initial state and transmitting the number to a termite-existing state block or an initial state block; determining whether proper handling is performed according to received handling information so as to calculate a number of monitoring points in an in-killing state and transmitting the number to the in-killing state block; determining whether killing is completed according to received review information and a review instruction so as to calculate a number of monitoring points in a killing-complete state and transmitting the number to the killing-complete state block; and determining where a device is off-line or lost according to duration for which a monitoring point is not kept in communication so as to calculate a number of monitoring points in an off-line state or lost state and transmitting the number to the off-line state block or the lost state block.

Optionally, the method further includes determining whether position change exceeds a threshold according to monitoring-point positioning information so as calculate a number of monitoring points in a displaced state and transmitting the number to a displaced state block.

Optionally, the method further includes subtracting the number of monitoring points in the initial state, the termite-existing state, the in-killing state, the killing-complete state, the off-line state, the lost state and the displaced state respectively from a total number of monitoring points to obtain a number of remaining monitoring points.

In order to achieve objects of the disclosure, a termite monitoring software platform is further provided in the disclosure, which includes a system for displaying a monitoring-point state, and the system for displaying the monitoring-point state performs a method for calculating a monitoring-point state when operated.

To achieve the objects of the present disclosure, a computer-readable storage medium is further provided in the present disclosure, in which a computer program or code set is stored, and the computer program or code set, when executed by a processor, realizes part or all of steps of a method for calculating a monitoring-point.

Compared with the prior art, the technical schemes provided in the disclosure have the following beneficial effects.

(1) At least 6 to 7 monitoring-point states are provided, and the numbers of monitoring points in respective states are displayed by separate program blocks, which is with independent data and more accurate.

(2) The initial state, the termite-existing state, the in-killing state, the killing-complete state, the shifting state, the off-line state and the lost state are all dynamically varied, and respectively reflect different states of termite monitoring, which facilitates knowledge of termite situation dynamics, and the numbers of monitoring points in the respective states can be intuitively displayed through real-time displayed data.

(3) Both the initial state and the termite-existing state are sensor feedback after the device is online without human intervention. With aid of some commonly used Internet of Things sensors, it can be detected whether termites exist, which is converted into digital signals and fed back to the termite monitoring software platform or directly transmitted to the corresponding initial state block or termite-existing state block through communication technologies such as NB-IoT, LoRa and LTE-Cat.1, so that it can be accurately distinguished whether the termites exist, and the termite-existing state can be transformed from the initial state or from the killing-complete state.

(4) After the termite-existing state is transmitted to the termite monitoring software platform in time by using the Internet of Things communication technology, a state of the handled monitoring points may be changed from the termite-existing state to the in-killing state, and termite killing takes a certain period of time. The in-killing state block provided by the disclosure can reflect that some of monitoring points have been handled and are in the in-killing state, and the monitoring points in the in-killing state can be changed to the killing-complete state after review and re-examination. In the disclosure, prevention and control and killing results of termites can be reflected through the killing-complete state block, but the killing-complete state is still variable and still be changed into the termite-existing state if termites exist at the monitoring points in the killing-complete state again. In this way, different states are clearly distinguished and flexible dynamics are maintained.

(5) In view of abnormal device, the displaced state block according to the disclosure can reflect a situation that a monitoring point deviates from its original installation position, and the off-line state block and the lost state block can reflect a situation that the device is not kept in continuous communication with the termite monitoring software platform for specific reasons, which facilitates finding an abnormal device or updating the device in time, avoids a situation the loopholes in the monitoring network occur and cannot be found in time, and also reflects maintenance of the termite monitoring software platform.

(6) The login permission configuration block is provided in this disclosure, which serves to configure different permissions for different types of users, and a corresponding operation range is allowed according to authority of users, so that external human intervention to the termite monitoring software platform and the system for displaying the monitoring-point state is strictly restricted, ensuring authenticity and accuracy of data.

(7) The monitoring point distribution profile block is further provided in this disclosure, and the monitoring point distribution profile block is associated with respective state blocks, so that state change of the monitoring points can be reflected on a map synchronously, which is more convenient for users to check positions of the monitoring points and occurrence and development of termite situation, which brings real-time and dynamic advantages and better user experience.

### BRIEF DESCRIPTION OF THE DRAWINGS

FIG. 1 is a schematic structural diagram of a system for displaying a monitoring-point state according to an embodiment of the present disclosure.

### DETAILED DESCRIPTION

Embodiments of the present disclosure will be described in detail below, examples of which are shown in the accompanying drawings, in which same or similar reference numerals refer to same or similar elements or elements with same or similar functions throughout. The embodiments described below with reference to the drawings are exemplary and are only intended to explain the present disclosure, but should not be construed as limiting the present disclosure.

In description of this disclosure, it should be noted that unless otherwise specified and limited, terms “installing”, “coupling” and “connecting” should be understood broadly, for example, it can be “fixedly connecting”, “integrally connecting”, or “detachably connecting”; or it can be “mechanically connecting” or “electrically connecting”, or it can be “communicating within two elements”; or it can be “directly connecting” or “indirectly connecting through an intermediate medium”, and specific meanings of the above terms can be understood according to specific situations for ordinary shilled in the art.

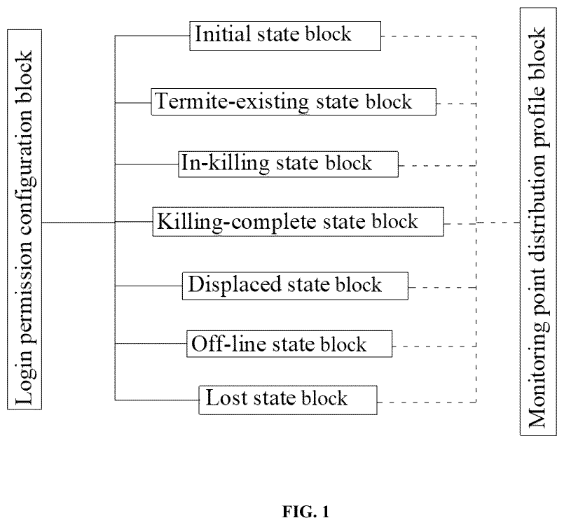

A system for displaying a monitoring-point state as shown in FIG. 1 includes an initial state block configured for displaying a number of monitoring points in an initial state; an termite-existing state block configured for displaying a number of monitoring points in an termite-existing state; an in-killing state block configured for displaying a number of monitoring points in an in-killing state; a killing-complete state block configured for displaying a number of monitoring points in a killing-complete state; an off-line state block configured for displaying a number of monitoring points in an off-line state; and a lost state block configured for displaying a number of monitoring points in a lost state. The monitoring point device and the termite monitoring software platform are connected in communication modes such as NB-IoT, LoRa, LTE-Cat.1, etc. After the monitoring point device is started, it is connected to the termite monitoring software platform, and the monitoring point device periodically sends a signal to report termite situation detected by Internet of Things sensors installed in the monitoring point device. This signal can provide two types of numerical or digital signals to represent whether termites exist or not, which simplifies judgment logic and makes digital signals more robust. The system for displaying the monitoring-point state further includes a displaced state block for displaying a number of monitoring points in a displaced state, and the displaced state block is also configured for calculating and recording the number of monitoring points in the displaced state. The system for displaying the monitoring-point state is further includes a display connected therewith, and image information displayed by the display includes a monitoring-point state display area, which is used to display names of states of the monitoring points and the number of the monitoring points provided by the initial state block, the termite-existing state block, the in-killing state block, the killing-complete state block, the off-line state block, the lost state block and the displaced state block. Text of the names of states of the monitoring points can be marked with different colors, for example, the initial state with a green color, termite-existing state with a red color, the in-killing state with an orange color, the killing-complete state with a yellow color, the displaced state with a purple color, the off-line state with a blue color, and the lost state with a pink color.

The initial state block is further configured for calculating and recording the number of monitoring points in the initial state, the termite-existing state block is further configured for calculating and recording the number of monitoring points in the termite-existing state, and the in-killing state block is further configured for calculating and recording the number of monitoring points in the in-killing state; the killed state block is further configured for calculating and recording the number of monitoring points in the killing-complete state; the off-line state block further configured for calculating and recording the number of monitoring points in the off-line state; and the lost state block is further configured for calculating and recording the number of monitoring points in the lost state. The termite monitoring software platform includes a memory. The numbers of monitoring points recorded by the initial state block, the termite-existing state block, the in-killing state block, the killing-complete state block, the off-line state block, the lost state block and the displaced state block are all stored in the memory. Stored information further involves a number of each monitoring point, an initial position of the monitoring point, a current position of the monitoring point and a time stamp of a signal sent by the monitoring point. Both an initial position or a current position of the monitoring point can be expressed by latitude and longitude information.

The system for displaying the monitoring-point state further includes a monitoring point distribution profile block for displaying distribution positions of monitoring points on the map. The monitoring point distribution profile block is associated with the initial state block, the termite-existing state block, the in-killing state block, the killing-complete state block, the off-line state block, the lost state block and the displaced state block. The monitoring point distribution profile can be displayed on the display, and a position of a respective monitoring point and its relative distance from an adjacent building or green space can be clearly seen on the monitoring point distribution profile. The monitoring point distribution profile block serves to receive information of the termite monitoring software platform for updating in real time. The monitoring points marked on a monitoring point list page or electronic map in different states can be distinguished by means of texts, colors, graphics, sounds, etc., so that users can intuitively know state changes of monitoring points. When a monitoring point on the electronic map is selected, the users can know specific information of the monitoring point, including a number of the monitoring point, a name of a state of the monitoring point, a position of the monitoring point and time of a latest state update, and the specific information of these monitoring points are all associated with the initial state block, the termite-existing state block, the in-killing state block, the killing-complete state block, the off-line state block, the lost state block and the displaced state block. With aid of display of the monitoring point distribution profile controlled by the monitoring point distribution profile block on the display, the users can clearly know current states and handling of respective monitoring points, and determine areas that need focus and prevention and control measures according to locations of the monitoring points at the same time.

The system for displaying the monitoring-point state further includes a monitoring point query block and a monitoring point ranking block connected with the memory, and the users can query and view information about a certain monitoring point stored in the memory through the number of the monitoring point, and the monitoring point ranking block can provide a monitoring point list page, on which the respective monitoring points can be ranked in an order of numbers of the monitoring points or according to states of the monitoring points. For example, a monitoring point in the termite-existing state can be sorted centrally and displayed in front.

The system for displaying the monitoring-point state further includes a login permission configuration block connected with the initial state block, the termite-existing state block, the in-killing state block, the killing-complete state block, the off-line state block, the lost state block and the displaced state block. The login permission configuration block can serve to configure different permissions for users with different responsibilities. For example, prevention and control personnel do not have permission to add, replace or delete monitoring points, while operation and maintenance personnel have this permission. While orderly operations of the termite monitoring software platform are maintained, accuracy of monitoring-point state data can be ensured and human intervention beyond the permission can be excluded as much as possible.

In order to achieve objects of the disclosure, a method for calculating a monitoring-point state is further provided in the disclosure, which includes: determining whether termite exists according to a signal sent by a monitoring point so as to calculate a number of monitoring points in a termite-existing state or an initial state and transmitting the number to a termite-existing state block or an initial state block; determining whether proper handling is performed according to received handling information so as to calculate a number of monitoring points in an in-killing state and transmitting the number to the in-killing state block; determining whether killing is completed according to received review information and a review instruction so as to calculate a number of monitoring points in a killing-complete state and transmitting the number to the killing-complete state block; and determining where a device is off-line or lost according to duration for which a monitoring point is not kept in communication so as to calculate a number of monitoring points in an off-line state or lost state and transmitting the number to the off-line state block or the lost state block. The handling information and review information both include a number of a monitoring point, a monitoring point device image and other information. When a monitoring point is in the in-killing state for a certain period of time, for example, after fourteen days, the termite monitoring software platform reminds that the monitoring point waits for review, the termite monitoring software platform automatically functions in reviewing or reminds the users to review after receiving the review information. When the review information and review instructions all indicate that killing has been completed, the in-killing state of the monitoring point is changed to the killing-complete state, and a number of monitoring points in a corresponding state also is changed synchronously. It is determined that the monitoring point is in the off-line state when duration for which the monitoring point is not kept in communication exceeds a first preset period of time, and it is determined that the monitoring point is in the lost state when duration for which the monitoring point is not kept in communication exceeds a second preset period of time, and the second preset period of time is greater than the first preset period of time. The method for calculating the monitoring-point state further includes determining whether termite exists according to the signal sent by the monitoring point so as to calculate a number of monitoring points in the termite-existing state or the killing-complete state, and transmitting the number to the termite-existing state block and the killing-complete state block. Termites may still be detected at a monitoring point in the killing-complete state again, which means that termites are found at the monitoring point, and the Internet of Things sensor can still send out a digital signal to report this situation, and the monitoring point also can be changed from the killing-complete state to the termite-existing state, and the number of related monitoring points can be changed synchronously at the same time.

The method for calculating the monitoring-point state further includes determining whether position change exceeds a threshold according to monitoring-point positioning information so as calculate a number of monitoring points in the displaced state and transmitting the number to the displaced state block. In a long period of time, due to various changes in actual installation positions, a position of an initially installed monitoring point may be changed, and the termite monitoring software platform can determine whether the change in position exceeds a preset threshold, such as 50 meters or 100 meters, by comparing an initial position of the monitoring point and a current position of the monitoring point to obtain deviation between them, and the threshold can be reasonably determined according to spacings between the monitoring points, so as to determine whether the monitoring point obviously deviates from the initial position. This may affect integrity of a monitoring point layout, and it is necessary to manually put the monitoring point device back to the initial position. When the monitoring point device is placed back to the initial position, it can be confirmed that the change in position has been eliminated or less than the threshold according to a signal sent by the monitoring point device again, and then it can be automatically restored to an original state, that is, a state before it becomes the displaced state. This change can be recorded by a corresponding state block, and a number of monitoring points calculated by this block can also be updated. The displaced state block functions to solve problems found in practical applications of the termite detection software platform, and can continuously focus on change in position of respective monitoring points, and report the displaced state to the users. The initial state, the termite-existing state, the in-killing state and the killing-complete state may all be updated to the displaced state due to change in position.

In another implementation, if it is determined according to latitude and longitude information of the current position of the monitoring point that the monitoring point is outside an area where the monitoring point is arranged for pest prevention and control, for example, outside a site of a cultural protection unit, even if the monitoring point device is still in communication with the termite monitoring software platform, it can still be determined that the monitoring point is in the lost state, and a position of the monitoring point and a corresponding graphic mark can be displayed on the electronic map, so as to facilitate the user to retrieve the monitoring point device.

The method for calculating the monitoring-point state further includes subtracting the number of monitoring points in the initial state, the termite-existing state, the in-killing state, the killing-complete state, the off-line state, the lost state and the displaced state respectively from a total number of monitoring points to obtain a number of remaining monitoring points. This step can serve to check a number of monitoring points, so as to avoid that a monitoring point device is not connected to the termite monitoring software platform due to other abnormal conditions that may occur to some monitoring points. Further, if the number of remaining monitoring points is found to be not zero, existing respective numbers of monitoring points can be compared with all numbers of monitoring points to find out numbers of monitoring points that have not sent out signals or are not marked with a state, so as to timely find out missing points and number and connect them again.

The initial state, the termite-existing state, the in-killing state and the killing-complete state may all updated to the off-line state because duration for which no signal is sent exceeds the first preset period of time, due to a fact that the monitoring point device continuously does not send out a signal for some reasons, while the monitoring point device in the off-line state is updated to be in the lost state because duration for which no signal is sent exceeds the second preset period of time, for example, the second preset period of time is seven days, and the first preset period of time is three days. If some interference factors are eliminated by manual operations or the device itself, the monitoring point device may send out a signal again, and can be updated to be in an original state because the monitoring point device resumes sending out the signal for a certain period of time, that is, a state before it becomes in the off-line or lost state. Both the termite monitoring software platform and the system for displaying the monitoring-point state may record state changes and update the number of monitoring points, which at the same time may be reflected on the display through the associated monitoring point distribution profile block. In this way, a complete and dynamically updated termite monitoring-point state display system is formed. Due to real-time dynamic updating of respective monitoring-point states, the users can know termite situations and states of monitoring point devices in a whole area where the monitoring point devices are installed, and monitoring points that need to be handled can be found timely and corresponding operations can be made.

When the initial state of the monitoring point is changed to the displaced state or the off-line state, the number of monitoring points displayed can be changed synchronously, and the number of monitoring points in the initial state decreases, while the number of monitoring points in the displaced state or off-line state increases. On the electronic map, a color of the monitoring point is displayed as the purple color for the displaced state or as the blue color for the off-line state, but when a mouse is moved to a graphic mark of the monitoring point, a number of the monitoring point and a name of a state of the monitoring point pop up. At this time, the name of the state of the monitoring point is “initial-displaced” or “initial-off-line”, which includes a current state of the monitoring point and a state of the monitoring point before change, and a historical state of the monitoring point stored in the memory is reused, and the historical state of the monitoring point can be used to restore the state of the monitoring point. After the monitoring point is changed from the off-line state to the lost state, it is not necessary to involve the off-line state before change. If the monitoring point device is handled, it can be directly restored from the lost state to a state before it becomes in the off-line state.

When the termite-existing state, the in-killing state, and the killing-complete state of the monitoring point is changed to the displaced state or the off-line state, it also with a color of a graphic mark displayed as the current state on the electronic map, that is, the purple color for the displaced state or the blue color for the off-line state. After handling, the monitoring point returns to its initial position or continues to keep in communication, and can still be restored to the termite-existing state, the in-killing state and the killing-complete state, and the number of monitoring points in a respective state changes synchronously, which is also recorded and displayed in the monitoring point list page as including a current state and a state before change, which is the same as a setting when information of a certain monitoring point is viewed on the electronic map, and both the current state of the monitoring point and a state of the monitoring point before change can be viewed.

In order to ensure that there is a certain period of time for completing the killing, the termite-existing state of the monitoring point cannot be directly transformed into the in-killing state, and intermediate submission of handling information, review information and review instructions is essential, which ensures accuracy of the in-killing state. However, the monitoring points in the killing-complete state can be changed to the termite-existing state after occurrence of termite, which may still be changed to the in-killing state, the displaced state, the off-line state or the lost state subsequently, and these state changes may occur before the submission of the handling information of the termite-existing state, which causes the termite monitoring software platform to still maintain alarm information of the termite-existing state after factors resulting in the displaced state, the off-line state or lost state are eliminated and after the monitoring point is restored to the termite-existing state, and users still need to submit the handling information. If the monitoring point is changed from the in-killing state to the displaced state, the off-line state or the lost state, it is still necessary to carry out a killing operation or corresponding handling again after returning to the in-killing state, and to totalize duration for the in-killing state again.

A termite monitoring software platform is further provided in the embodiment of the disclosure, which includes a system for displaying a monitoring-point state, and the system for displaying the monitoring-point state performs a method for calculating a monitoring-point state when operated. The initial state block, the termite-existing state block, the in-killing state block, the killing-complete state block, the off-line state block, the lost state block and the displaced state block included in the system for displaying the monitoring-point state provide 6 to 7 practical monitoring-point states and a calculated number of monitoring points in a respective state, so that the users can have a comprehensive and dynamic real-time knowledge of an operation state of a monitoring point device, and both an pest alarm and a handling state of the monitoring point device and an operation and maintenance state of the device itself are taken into account, and completeness of all of monitoring point devices and convenience and accuracy of termite monitoring are ensured with the Internet of Things technology, which greatly improves efficiency and effect of pest prevention and control.

A computer-readable storage medium is further provided in the embodiment of the present disclosure, in which a computer program or code set is stored, and the computer program or code set, when executed by a processor, realizes part or all of steps of a method for calculating a monitoring-point. The computer includes a personal computer, a tablet computer, a notebook computer, a palmtop computer, a mobile phone or a server.

The computer-readable storage medium can be a computer-readable signal medium or a computer-readable storage medium or any combination of the above two. The computer-readable storage medium can be, for example, but not limited to, an electrical, magnetic, optical, electromagnetic, infrared or semiconductor system, means or device, a magnetic card, an IC card, a USB flash drive, a SD card, etc. More specific examples of the computer-readable storage media may include, but are not limited to, electrical connections with one or more wires, portable computer disks, hard disks, random access memories (RAM), read-only memories (ROM), erasable programmable read-only memories (EPROM or flash memories), portable compact disk read-only memories (CD-ROMs), optical storage devices, magnetic storage devices, or any combination of the above. The computer-readable storage medium can be any tangible medium containing or storing a program, which can be used by or in combination with an instruction execution system, apparatus or device. The computer-readable signal medium may include a data signal propagated in baseband or as a part of a carrier wave in which the computer-readable program code is carried. This propagated data signal can take various forms, including but not limited to an electromagnetic signal, an optical signal or any combination of the above. A computer-readable signal medium can also be any computer-readable storage medium other than a computer-readable storage medium, which can send, propagate or transmit a program for use by or in connection with an instruction execution system, apparatus or device. The program code contained in the computer-readable storage medium can be transmitted with any suitable medium, including but not limited to: wireless, wired, optical cable, radio frequency signal, etc.

The above embodiments are only intended to illustrate technical schemes of the present disclosure, but not to limit it. Although the present disclosure has been described in detail with reference to foregoing embodiments, it should be understood by those skilled in the art that the technical schemes described in the foregoing embodiments can still be modified, or some or all of their technical features can be replaced by equivalents; and these modifications or substitutions do not make essence of corresponding technical schemes deviate from the scope of the technical schemes of various embodiments of the present disclosure.

What is claimed is:

1. A system for displaying a monitoring-point state, comprising:
a display configured for displaying a plurality of state-displaying blocks,
wherein the plurality of state-displaying blocks, comprises:
an initial state block configured for displaying a number of monitoring points in an initial state;
a termite-existing state block configured for displaying a number of monitoring points in an termite-existing state;
an in-killing state block configured for displaying a number of monitoring points in an in-killing state;
a killing-complete state block configured for displaying a number of monitoring points in a killing-complete state;
an off-line state block configured for displaying a number of monitoring points in an off-line state; and
a lost state block configured for displaying a number of monitoring points in a lost state;
wherein the initial state block is further configured for calculating and recording the number of monitoring points in the initial state, the termite-existing state block is further configured for calculating and recording the number of monitoring points in the termite-existing state, and the in-killing state block is further configured for calculating and recording the number of monitoring points in the in-killing state; the killed state block is further configured for calculating and recording the number of monitoring points in the killing-complete state; the off-line state block further configured for calculating and recording the number of monitoring points in the off-line state; and the lost state block is further configured for calculating and recording the number of monitoring points in the lost state;
the plurality of state-displaying blocks further comprises a displaced state block for displaying a number of monitoring points in a displaced state; and
the plurality of state-displaying blocks further comprises a monitoring point distribution profile block for displaying distribution positions of monitoring points on the map, wherein the monitoring point distribution profile block is associated with the initial state block, the termite-existing state block, the in-killing state block, the killing-complete state block, the off-line state block, the lost state block and the displaced state block;
the monitoring point distribution profile is displayed on the display, and a position of a respective monitoring point and its relative distance from an adjacent building or green space is clearly seen on the monitoring point distribution profile; the monitoring point distribution profile block serves to receive information of the termite monitoring software platform for updating in real time; the monitoring points marked on a monitoring point list page or electronic map in different states are distinguished by means of texts, colors, graphics, sounds, etc., so that users can intuitively know state changes of monitoring points; and when a monitoring point on the electronic map is selected, the users know specific information of the monitoring point, including a number of the monitoring point, a name of a state of the monitoring point, a position of the monitoring point and time of a latest state update, and specific information of these monitoring points are all associated with the initial state block, the termite-existing state block, the in-killing state block, the killing-complete state block, the off-line state block, the lost state block and the displaced state block; with aid of display of the monitoring point distribution profile controlled by the monitoring point distribution profile block on the display, the users clearly know current states and handling of respective monitoring points, and determine areas that need focus and prevention and control measures according to locations of the monitoring points at the same time;
when the monitoring point device is placed back to the initial position, it is confirmed that the change in position has been eliminated or less than the threshold according to a signal sent by the monitoring point device again, and then the monitoring point device is automatically restored to an original state, that is, a state before the monitoring point device becomes the displaced state; and this change is recorded by a corresponding state block, and a number of monitoring points calculated by the block is also updated; and the displaced state block functions to solve problems found in practical applications of the termite detection software platform, and continuously focuses on change in position of respective monitoring points, and reports the displaced state to the users; and the initial state, the termite-existing state, the in-killing state and the killing-complete state are all updated to the displaced state due to change in position.

2. The system for displaying the monitoring-point state according to claim 1, wherein the plurality of state-displaying blocks further comprises a login permission configuration block connected with the initial state block, the termite-existing state block, the in-killing state block, the killing-complete state block, the off-line state block, the lost state block and the displaced state block.

3. A method for calculating a monitoring-point state applied to a system for displaying the monitoring-point state, comprising:
determining whether termite exists according to a signal sent by a monitoring point so as to calculate a number of monitoring points in a termite-existing state or an initial state and transmitting the number to a termite-existing state block or an initial state block;
determining whether proper handling is performed according to received handling information so as to calculate a number of monitoring points in an in-killing state and transmitting the number to an in-killing state block;
determining whether killing is completed according to received review information and a review instruction so as to calculate a number of monitoring points in a killing-complete state and transmitting the number to a killing-complete state block; and
determining where a device is off-line or lost according to duration for which a monitoring point is not kept in communication so as to calculate a number of monitoring points in an off-line state or a lost state and transmitting the number to an off-line state block or a lost state block; and
further comprising determining whether position change exceeds a threshold according to monitoring-point positioning information so as calculate a number of monitoring points in the displaced state and transmitting the number to the displaced state block;
wherein the system for displaying the monitoring-point state comprises:
a display configured for displaying a plurality of state-displaying blocks,
wherein the plurality of state-displaying blocks, comprises:
the initial state block configured for displaying a number of monitoring points in an initial state;
the termite-existing state block configured for displaying a number of monitoring points in an termite-existing state;
the in-killing state block configured for displaying a number of monitoring points in an in-killing state;
the killing-complete state block configured for displaying a number of monitoring points in a killing-complete state;
the off-line state block configured for displaying a number of monitoring points in an off-line state; and
the lost state block configured for displaying a number of monitoring points in a lost state;
wherein the initial state block is further configured for calculating and recording the number of monitoring points in the initial state, the termite-existing state block is further configured for calculating and recording the number of monitoring points in the termite-existing state, and the in-killing state block is further configured for calculating and recording the number of monitoring points in the in-killing state; the killed state block is further configured for calculating and recording the number of monitoring points in the killing-complete state; the off-line state block further configured for calculating and recording the number of monitoring points in the off-line state; and the lost state block is further configured for calculating and recording the number of monitoring points in the lost state;
the plurality of state-displaying blocks further comprises a displaced state block for displaying a number of monitoring points in a displaced state; and
the plurality of state-displaying blocks further comprises a monitoring point distribution profile block for displaying distribution positions of monitoring points on the map, wherein the monitoring point distribution profile block is associated with the initial state block, the termite-existing state block, the in-killing state block, the killing-complete state block, the off-line state block, the lost state block and the displaced state block;
the monitoring point distribution profile is displayed on the display, and a position of a respective monitoring point and its relative distance from an adjacent building or green space is clearly seen on the monitoring point distribution profile; the monitoring point distribution profile block serves to receive information of the termite monitoring software platform for updating in real time; the monitoring points marked on a monitoring point list page or electronic map in different states are distinguished by means of texts, colors, graphics, sounds, etc., so that users can intuitively know state changes of monitoring points; and when a monitoring point on the electronic map is selected, the users know specific information of the monitoring point, including a number of the monitoring point, a name of a state of the monitoring point, a position of the monitoring point and time of a latest state update, and specific information of these monitoring points are all associated with the initial state block, the termite-existing state block, the in-killing state block, the killing-complete state block, the off-line state block, the lost state block and the displaced state block; with aid of display of the monitoring point distribution profile controlled by the monitoring point distribution profile block on the display, the users clearly know current states and handling of respective monitoring points, and determine areas that need focus and prevention and control measures according to locations of the monitoring points at the same time;
when the monitoring point device is placed back to the initial position, it is confirmed that the change in position has been eliminated or less than the threshold according to a signal sent by the monitoring point device again, and then the monitoring point device is automatically restored to an original state, that is, a state before the monitoring point device becomes the displaced state; and this change is recorded by a corresponding state block, and a number of monitoring points calculated by the block is also updated; and the displaced state block functions to solve problems found in practical applications of the termite detection software platform, and continuously focuses on change in position of respective monitoring points, and reports the displaced state to the users; and the initial state, the termite-existing state, the in-killing state and the killing-complete state are all updated to the displaced state due to change in position.

4. The method for calculating the monitoring-point state according to claim 3, further comprising subtracting the number of monitoring points in the initial state, the termite-existing state, the in-killing state, the killing-complete state, the off-line state, the lost state and the displaced state respectively from a total number of monitoring points to obtain a number of remaining monitoring points.

5. A termite monitoring software platform, comprising the system for displaying the monitoring-point state according to claim 1, the system for displaying the monitoring-point state performing a method for calculating the monitoring-point state when operated;
wherein the method for calculating the monitoring-point state comprises:
determining whether termite exists according to a signal sent by a monitoring point so as to calculate a number of monitoring points in a termite-existing state or an initial state and transmitting the number to a termite-existing state block or an initial state block;
determining whether proper handling is performed according to received handling information so as to calculate a number of monitoring points in an in-killing state and transmitting the number to the in-killing state block;
determining whether killing is completed according to received review information and a review instruction so as to calculate a number of monitoring points in a killing-complete state and transmitting the number to the killing-complete state block; and
determining where a device is off-line or lost according to duration for which a monitoring point is not kept in communication so as to calculate a number of monitoring points in an off-line state or lost state and transmitting the number to the off-line state block or the lost state block; and
further comprises determining whether position change exceeds a threshold according to monitoring-point positioning information so as calculate a number of monitoring points in the displaced state and transmitting the number to the displaced state block.

6. The termite monitoring software platform according to claim 5, wherein the method for calculating the monitoring-point state further comprises:
subtracting the number of monitoring points in the initial state, the termite-existing state, the in-killing state, the killing-complete state, the off-line state, the lost state and the displaced state respectively from a total number of monitoring points to obtain a number of remaining monitoring points.

7. A termite monitoring software platform, comprising the system for displaying the monitoring-point state according to claim 2, the system for displaying the monitoring-point state performing a method for calculating the monitoring-point state when operated,
wherein the method for calculating the monitoring-point state comprises:
determining whether termite exists according to a signal sent by a monitoring point so as to calculate a number of monitoring points in a termite-existing state or an initial state and transmitting the number to a termite-existing state block or an initial state block;
determining whether proper handling is performed according to received handling information so as to calculate a number of monitoring points in an in-killing state and transmitting the number to the in-killing state block;
determining whether killing is completed according to received review information and a review instruction so as to calculate a number of monitoring points in a killing-complete state and transmitting the number to the killing-complete state block; and
determining where a device is off-line or lost according to duration for which a monitoring point is not kept in communication so as to calculate a number of monitoring points in an off-line state or lost state and transmitting the number to the off-line state block or the lost state block; and
further comprises determining whether position change exceeds a threshold according to monitoring-point positioning information so as calculate a number of monitoring points in the displaced state and transmitting the number to the displaced state block.

8. The termite monitoring software platform according to claim 7, wherein the method for calculating the monitoring-point state further comprises:
subtracting the number of monitoring points in the initial state, the termite-existing state, the in-killing state, the killing-complete state, the off-line state, the lost state and the displaced state respectively from a total number of monitoring points to obtain a number of remaining monitoring points.

9. A computer-readable storage medium, wherein a computer program or code set is stored in the computer-readable storage medium, and the computer program or code set, when executed by a processor, realizes a method for calculating the monitoring-point state,
wherein the method for calculating the monitoring-point state comprises:
determining whether termite exists according to a signal sent by a monitoring point so as to calculate a number of monitoring points in a termite-existing state or an initial state and transmitting the number to a termite-existing state block or an initial state block;
determining whether proper handling is performed according to received handling information so as to calculate a number of monitoring points in an in-killing state and transmitting the number to the in-killing state block;
determining whether killing is completed according to received review information and a review instruction so as to calculate a number of monitoring points in a killing-complete state and transmitting the number to the killing-complete state block; and
determining where a device is off-line or lost according to duration for which a monitoring point is not kept in communication so as to calculate a number of monitoring points in an off-line state or lost state and transmitting the number to the off-line state block or the lost state block; and
further comprises determining whether position change exceeds a threshold according to monitoring-point positioning information so as calculate a number of monitoring points in the displaced state and transmitting the number to the displaced state block.

10. The computer-readable storage medium according to claim 9, wherein the method for calculating the monitoring-point state further comprises:
subtracting the number of monitoring points in the initial state, the termite-existing state, the in-killing state, the killing-complete state, the off-line state, the lost state and the displaced state respectively from a total number of monitoring points to obtain a number of remaining monitoring points.
